(19) United States
(12) Patent Application Publication
(10) Pub. No.: US 2024/0332595 A1
(43) Pub. Date: Oct. 3, 2024

(54) BATTERY MODULE

(71) Applicant: HONDA MOTOR CO., LTD., Tokyo (JP)

(72) Inventors: Hidemasa USUI, Saitama (JP); Masanari HIGUCHI, Saitama (JP)

(21) Appl. No.: 18/586,561

(22) Filed: Feb. 26, 2024

(30) Foreign Application Priority Data
Mar. 31, 2023 (JP) 2023-059350

(51) Int. Cl. H01M 10/04; H01M 10/052; H01M 50/293

(52) U.S. Cl. CPC H01M 10/0468; H01M 50/293; H01M 10/052

(57) ABSTRACT

A battery module includes a battery cell stack including a plurality of battery cells stacked therein, a pair of plate-shaped members provided on both ends of the battery cell stack in a stacking direction, and a buffer material provided between the plurality of battery cells and/or between the battery cell and the plate-shaped member. The buffer material includes an exterior member filled with a fluid. The exterior member includes an outer peripheral portion. When viewed from a top of the battery cell in the stacking direction, the outer peripheral portion of the exterior member includes a stretchable member at least at a portion of the outer peripheral portion.

This application is based on and claims the benefit of priority from Japanese Patent Application 2023-059350, filed on 31 Mar. 2023, the content of which is incorporated herein by reference.

### BACKGROUND OF THE INVENTION

### Field of the Invention

The present invention relates to a battery module.

### Related Art

In recent years, research and development have been carried out on battery modules that contribute to energy efficiency in order for many people to be able to ensure access to energy that is reasonable, reliable, sustainable, and advanced.

The battery module includes, for example, a battery cell stack in which a plurality of battery cells are stacked, and a pair of end plates provided at both ends of the battery cell stack in the stacking direction. Since the battery cells expand and contract with charge and discharge, a buffer material is disposed between the battery cells and between the battery cells and the end plate.

For example, Patent Document 1 describes a pressurized electrochemical battery including a plurality of connectors, at least one electrochemical cell having a plurality of collecting portions of electrical energy connected to the connectors, and at least one deformable chamber disposed in contact with the electrochemical cell. Here, the electrochemical cell includes a plurality of electrode sheets and a plurality of solid electrolyte sheets provided between the electrode sheets, and the deformable chamber is supplied with a fluid that deforms the chamber to apply pressure to the electrochemical cell. The deformable chamber is also connected to a collection system for fluid supply, and the collection system includes a supply system for controlling the amount of flow into the collection system and a pressure regulator for adjusting the pressure within the deformable chamber.
Patent Document 1: Japanese Unexamined Patent Application, Publication No. 2020-64848

### SUMMARY OF THE INVENTION

However, the pressurized electrochemical battery of Patent Document 1 needs to use the collection system to adjust the supply of fluid to the chamber in order to deform the chamber following expansion and contraction accompanying charging and discharging of the electrochemical cell.

Therefore, it is desirable to deform the buffer material without changing the filling amount of the fluid in the buffer material. However, when the volume of the buffer material is reduced in order to increase the energy density of the battery module, the pressure of the fluid increases as the buffer material contracts following the expansion accompanying charging of the battery cell. Therefore, in order to maintain the durability of a battery module, it is necessary to reinforce the end plate, and as a result, the energy density of the battery module decreases.

An object of the present invention is to provide battery modules that are each able to improve energy density without changing a filling amount of a fluid in a buffer material.

(1) A battery module including: a battery cell stack including a plurality of battery cells stacked therein; a pair of plate-shaped members provided on both ends of the battery cell stack in a stacking direction; and a buffer material provided between the plurality of battery cells and/or between the battery cell and the plate-shaped member, in which the buffer material includes an exterior member filled with a fluid, and the exterior member includes an outer peripheral portion, and when viewed from a top of the battery cell in the stacking direction, the outer peripheral portion of the exterior member includes a stretchable member at least at a portion of the outer peripheral portion.

(2) The battery module according to (1), in which the exterior member is a stretchable member, and includes a first region and a second region connected to the first region and having a Young's modulus lower than that of the first region, and when viewed from a top of the battery cell in the stacking direction, the outer peripheral portion of the exterior member includes the first region at least at a portion of the outer peripheral portion.

(3) The battery module according to (2), in which the exterior member further includes a third region having a Young's modulus higher than that of the second region, and the first region and the second region are connected to each other via the third region.

(4) The battery module according to (2) or (3), in which when viewed from a top of the battery cell in the stacking direction, the outer peripheral portion of the exterior member includes the first region on a side where a tab lead of the battery cell is disposed.

(5) The battery module according to any one of (2) to (4), in which the stretchable member has an average thickness of 0.4 mm or less.

(6) The battery module according to any one of (2) to (5), in which the fluid in the first region has a maximum value for volume of 10 mL or more and 40 mL or less.

(7) The battery module according to any one of (1) to (6), in which the fluid is a gas.

According to the present invention, it is possible to provide battery modules that are each able to improve energy density without changing a filling amount of a fluid in a buffer material.

### BRIEF DESCRIPTION OF THE DRAWINGS

FIG. 1 is a cross-sectional view showing an example of a battery module of an embodiment of the present invention;

FIG. 2 is a schematic cross-sectional view showing a state in which the buffer material of FIG. 1 is not charged;

FIG. 3 is a schematic cross-sectional view showing a state in which the buffer material of FIG. 1 is fully charged;

FIG. 4 provides simulation results showing the relationship between the thickness of a buffer material and the surface pressure of a battery cell when the volume of a fluid existing in a first region is changed in the state shown in FIG. 3;

FIG. 5 provides simulation results showing the relationship between the volume of the fluid existing in the first region and the surface pressure of the battery cell at the time of full charge when the thickness of the buffer material is 1 mm; and

FIG. 6 is a schematic cross-sectional view showing a state of not being charged of a modified example of the buffer material of FIG. 1.

### DETAILED DESCRIPTION OF THE INVENTION

Hereinafter, embodiments of the present invention will be described with reference to the accompanying drawings.

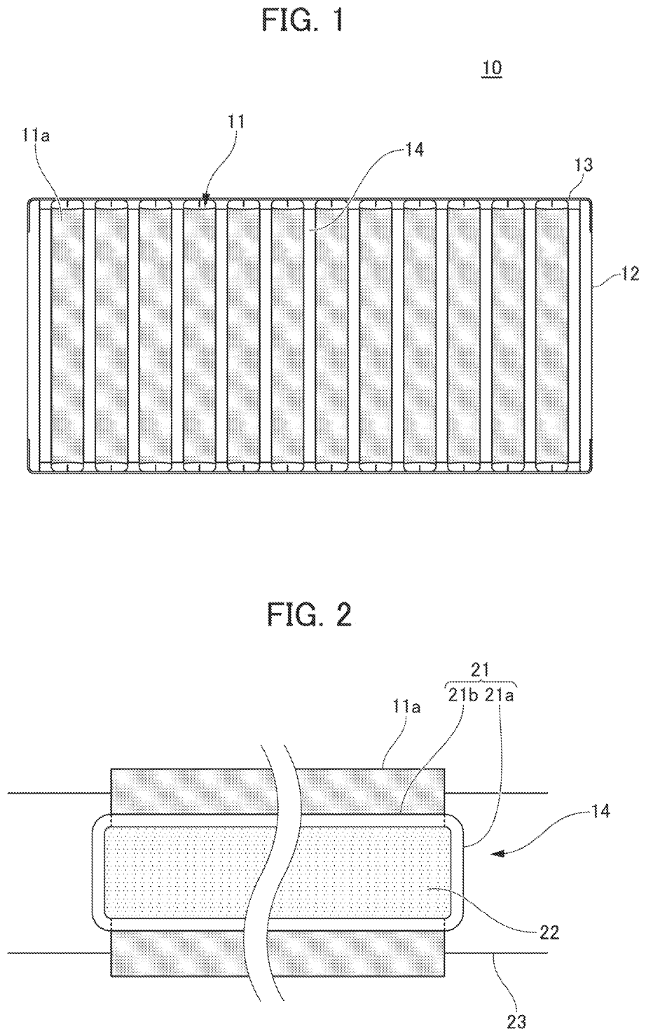

FIG. 1 shows an example of a battery module according to an embodiment of the present invention.

A battery module 10 includes a battery cell stack 11 in which a plurality of battery cells 11a are stacked, an end plate 12 as a pair of plate-shaped members provided at both ends of the battery cell stack 11 in the stacking direction, and a binding bar 13 serving as a restraining member for restraining the battery cell stack 11 between the pair of end plates 12. Here, the binding bar 13 is installed at two locations, that is, at an upper portion and a lower portion in the drawings. Here, the restraining pressure by the binding bar 13 is not particularly limited, but is, for example, 1.0 MPa or more and 2.5 MPa or less. In the battery module 10, a buffer material 14 is disposed between a plurality of battery cells 11a and between the battery cells 11a and the end plate 12.

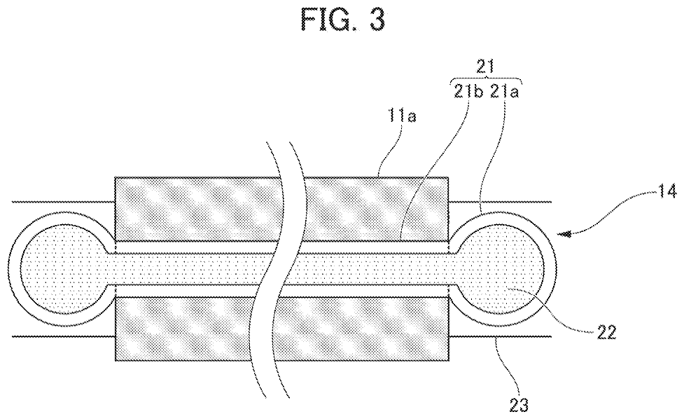

As shown in FIGS. 2 and 3, in the buffer material 14, an exterior member 21 is filled with a fluid 22. Here, the exterior member 21 is a stretchable member, and has a first region 21a and a second region 21b connected to the first region 21a and having a Young's modulus lower than that of the first region 21a, for example. Further, when viewed from the top in the stacking direction of the battery cells 11a, the first region 21a exists on the side where the tab leads 23 of the battery cells 11a are arranged (both end portions in the left-right direction in the drawings) in the outer peripheral portion of the exterior member 21. Therefore, when the buffer material 14 contracts following the expansion accompanying charging of the battery cell 11a, the first region 21a is likely to expand, so that an increase in pressure of the fluid 22 is suppressed (see FIG. 3). As a result, the durability of the battery module 10 is maintained without reinforcing the end plate 12. Further, when the buffer material 14 expands following the contraction of the battery cell 11a due to the discharge, the first region 21a is likely to contract (see FIG. 2). Therefore, in the battery module 10, the energy density is improved without changing the filling amount of the fluid 22 in the buffer material 14. Further, the dead space of the battery cell 11a on the side where the tab leads 23 are arranged is effectively utilized.

In addition, when viewed from the top in the stacking direction of the battery cells 11a, the first region 21a may exist in at least a portion of the outer peripheral portion of the exterior member 21. For example, the first region 21a may exist in one end of the outer peripheral portion of the exterior member 21 in the left-right direction in the drawings, or may exist in the entire region of the outer peripheral portion of the exterior member 21.

Further, when viewed from the top in the stacking direction of the battery cells 11a, the boundary between the first region 21a and the second region 21b is located at the end portion of the battery cell 11a, but may be located in the region opposed to the battery cell 11a or in a region not opposed to the battery cell 11a as long as the boundary is located in the vicinity of the end portion of the battery cell 11a.

The material of the buffer material 14 is not particularly limited as long as it can follow expansion and contraction due to charge and discharge of the battery cell 11a, and examples thereof include rubber, elastomer, and stretchable resin. Examples of the rubber include ethylene-propylene rubber, nitrile rubber, fluorine rubber, chloroprene rubber, and urethane rubber. Examples of the elastomer include styrene elastomers and olefin elastomers. Examples of the stretchable resin include polypropylene and polyamide.

The Young's modulus of the first region 21a is not particularly limited as long as it can suppress an increase in the pressure of the fluid 22, but is, for example, 3 MPa or more and 500 MPa or less. Further, the Young's modulus of the second region 21b is not particularly limited as long as the Young's modulus can follow expansion and contraction due to charge and discharge of the battery cell 11a, but is, for example, 2 MPa or more and 100 MPa or less. The Young's modulus of the first region 21a and the second region 21b largely varies depending on the thickness.

The Young's modulus of each of the first region 21a and the second region 21b can be adjusted, for example, by changing the materials of the first region 21a and the second region 21b and the thicknesses of the first region 21a and the second region 21b.

The average thickness of the exterior member 21 is preferably 0.4 mm or less, and more preferably 0.2 mm or less. When the average thickness of the exterior member 21 is 0.4 mm or less, expansion of the buffer material 14 during discharging of the battery cell 11a is suppressed, and as a result, the energy density of the battery module 10 during discharging of the battery cell 11a is improved. The average thickness of the exterior member 21 is not particularly limited, but is, for example, 0.1 mm or more.

The maximum volume of the fluid 22 existing in the first region 21a, i.e., the volume of the fluid 22 existing in the first region 21a when the battery cell 11a is fully charged, is preferably 10 mL or more and 40 mL or less. When the maximum value of the volume of the fluid 22 existing in the first region 21a is 10 mL or more and 40 mL or less, expansion of the buffer material 14 during discharging of the battery cell 11a is suppressed, and as a result, the energy density of the battery module 10 is improved.

The fluid 22 may be either a liquid or a gas, but is preferably a gas because it can easily follow the expansion and contraction accompanying charge and discharge of the battery cell 11a.

In addition, the exterior member 21 may not be a stretchable member, and the stretchable member may exist in at least a partial region (for example, the first region 21a) of the outer peripheral portion of the exterior member 21 when viewed from the top in the stacking direction of the battery cells 11a. In this case, the Young's modulus of the second region 21b may not be lower than that of the first region 21a. For example, even when the Young's modulus of the first region 21a and the second region 21b are the same, the energy density of the battery module 10 can be improved without changing the filling amount of the fluid 22 in the buffer material 14.

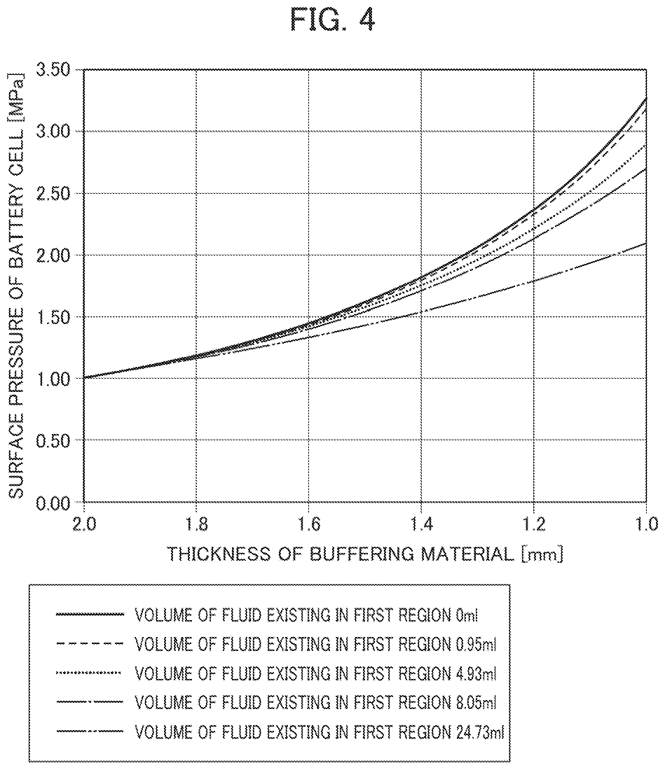

FIG. 4 shows the relationship between the thickness of the buffer material 14 and the surface pressure of the battery cell 11a when the volume of the fluid 22 existing in the first region 21a is changed in the state shown in FIG. 3 (during full charge). Here, a simulation is performed in which the battery cell 11a is charged from SOC 0% (10° C.) to SOC 100% (75° C.), and the thickness of the exterior member 21 is 0.2 mm.

In FIG. 4, it is evident that, when the volume of the fluid 22 existing in the first region 21a at the time of full charge is 0 ml, the surface pressure of the battery cell 11a becomes large, and when the volume of the fluid 22 existing in the first region 21a at the time of full charge becomes large, the surface pressure of the battery cell 11a becomes small.

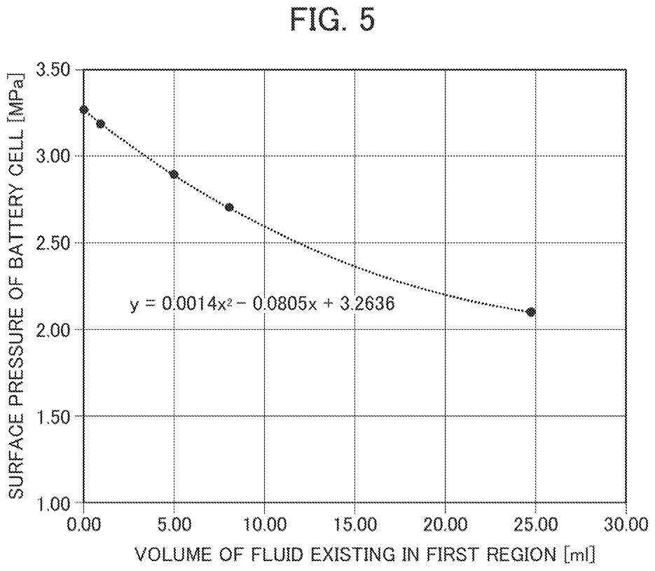

FIG. 5 shows the relationship between the volume of the fluid 22 existing in the first region 21a and the surface pressure of the battery cell 11a when the thickness of the buffer material 14 is 1 mm.

It is evident from FIG. 5 that, when the thickness of the buffer material 14 is set to about 1 mm in consideration of the energy density of the battery module 10, it is necessary to set the volume of the fluid 22 existing in the first region 21a at a predetermined value or more in order to set the surface pressure of the battery cell 11a to a predetermined value or less.

Further, the buffer material 14 may be disposed between the plurality of battery cells 11a or between the battery cells 11a and the end plate 12.

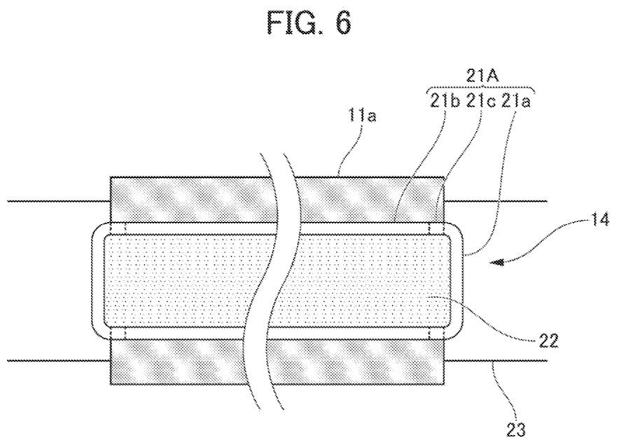

Further, instead of using the exterior member 21, an exterior member 21A may be used which further includes a third region 21c having a Young's modulus higher than that of the second region 21b and via which the first region 21a and the second region 21b are connected to each other (see FIG. 6). As a result, the rigidity of the third region 21c increases, so that the durability of the buffer material 14 is improved.

The Young's modulus of the third region 21c is not particularly limited as long as the durability of the buffer material 14 can be improved, but is, for example, 5 MPa or more and 10 GPa or less.

The Young's modulus of the third region 21c can be adjusted, for example, by changing the material of the third region 21c, the thickness of the third region 21c, or by attaching a tape to the inner surface and/or the outer surface of the third region 21c.

The tape is not particularly limited as long as the rigidity of the third region 21c can be increased, and examples thereof include high rigidity tapes obtained by impregnating continuous fibers such as glass fibers and carbon fibers with a resin such as polyamide.

The battery cell 11a is not particularly limited, and examples thereof include solid battery cells such as all-solid lithium ion battery cells and all-solid lithium metal battery cells, and non-aqueous electrolyte battery cells such as lithium metal battery cells. Among them, a solid-state battery cell is preferable.

Hereinafter, a case where the solid-state battery cell is an all-solid lithium metal battery cell will be described.

In the all-solid lithium metal battery cell, for example, a positive electrode collector, a positive electrode mixed material layer, a solid electrolyte layer, a lithium metal layer, and a negative electrode collector are sequentially laminated.

The positive electrode collector is not particularly limited, and examples thereof include aluminum foil.

The positive electrode mixed material layer contains a positive electrode active material, and may further contain a solid electrolyte, a conductive auxiliary agent, a binder, and the like.

Examples of the positive electrode active material include, but are not limited to, LiCoO₂, Li (Ni_{5/10}Co_{2/10}Mn_{3/10}) O₂, Li (Ni_{6/10}Co_{2/10}Mn_{2/10})O₂, Li (Ni_{8/10}Co_{1/10}Mn_{1/10})O₂, Li (Ni_{0.8}Co_{0.15}Al_{0.15})O₂, Li (Ni_{1/6}Co_{4/6}Mn_{1/6})O₂, Li (Ni_{1/3}Co_{1/3}Mn_{1/3})O₂, LiCoO₄, LiMn₂O₄, LiNiO₂, LiFePO₄, lithium sulfide, sulfur and the like as long as the positive electrode active material can absorb and release lithium ions.

The solid electrolyte constituting the solid electrolyte layer is not particularly limited as long as it is a material capable of conducting lithium ions, and examples thereof include an oxide electrolyte and a sulfide electrolyte.

The negative electrode collector is not particularly limited, and examples thereof include copper foil.

Although embodiments of the present invention have been described above, the present invention is not limited to the above-described embodiments, and the above-described embodiments may be appropriately modified within the scope of the present invention.

### EXPLANATION OF REFERENCE NUMERALS

10 battery module
11 battery cell stack
11a battery cell
12 end plate
13 binding bar
14 buffer material
21 and 21a exterior member
21a first region
21b second region
21c third region
22 fluid
23 tub lead

What is claimed is:

1. A battery module comprising:
a battery cell stack including a plurality of battery cells stacked therein;
a pair of plate-shaped members provided on both ends of the battery cell stack in a stacking direction; and
a buffer material provided between the plurality of battery cells and/or between the battery cell and the plate-shaped member,
wherein the buffer material includes an exterior member filled with a fluid, and
the exterior member includes an outer peripheral portion, and when viewed from a top of the battery cell in the stacking direction, the outer peripheral portion of the exterior member includes a stretchable member at least at a portion of the outer peripheral portion.

2. The battery module according to claim 1, wherein
the exterior member is a stretchable member, and includes a first region and a second region connected to the first region and having a Young's modulus lower than that of the first region, and
when viewed from a top of the battery cell in the stacking direction, the outer peripheral portion of the exterior member includes the first region at least at a portion of the outer peripheral portion.

3. The battery module according to claim 2, wherein
the exterior member further includes a third region having a Young's modulus higher than that of the second region, and
the first region and the second region are connected to each other via the third region.

4. The battery module according to claim 2, wherein when viewed from a top of the battery cell in the stacking direction, the outer peripheral portion of the exterior member includes the first region on a side where a tab lead of the battery cell is disposed.

5. The battery module according to claim 2, wherein the exterior member has an average thickness of 0.4 mm or less.

6. The battery module according to claim 2, wherein the fluid in the first region has a maximum value for volume of 10 mL or more and 40 mL or less.

7. The battery module according to claim 1, wherein the fluid is a gas.
